(19) United States
(12) Patent Application Publication
(10) Pub. No.: US 2022/0368515 A1
(43) Pub. Date: Nov. 17, 2022

(54) APPRATUS AND METHOD FOR GENERATING FULLY HOMOMORPHIC CODE, APPRATUS AND METHOD FOR DETECTING ERRORS OF FULLY HOMOMORPHIC CODE, APPRATUS AND METHOD FOR DETECTING ERRORS OF PROCESSING OF FULLY HOMOMORPHIC CODE, AND APPRATUS AND METHOD FOR DECODING FULLY HOMOMORPHIC CODE

(71) Applicants: INDUSTRY ACADEMIC COOPERATION FOUNDATION CHOSUN UNIVERSITY, Gwangju (KR); DAEGU GYEONGBUK INSTITUTE OF SCIENCE AND TECHNOLOGY, Daegu (KR); Seoul National University R&DB Foundation, Seoul (KR)

(72) Inventors: Young Sik KIM, Gwangju (KR); Yongjune KIM, Daegu (KR); Jong Seon NO, Seoul (KR)

(21) Appl. No.: 17/740,815

(22) Filed: May 10, 2022

(30) Foreign Application Priority Data
May 11, 2021 (KR) 10-2021-0060751

(51) Int. Cl. H04L 9/00

(52) U.S. Cl. CPC H04L 9/008

(57) ABSTRACT

Provided is a method for generating a fully homomorphic code, which includes: generating an Idempotent polynomial; and generating a fully homomorphic code message by using the generated Idempotent polynomial and a message.

### CROSS-REFERENCE TO RELATED APPLICATIONS

This application claims the priority of Korean Patent Application No. 10-2021-0060751 filed on May 11, 2021, in the Korean Intellectual Property Office, the entire disclosure of which is incorporated herein by reference.

### BACKGROUND

### Field

The present disclosure relates to a method and an apparatus for generating a fully homomorphic code.

### Description of the Related Art

As a technique of detecting errors which randomly occur, there is an error correcting code. It is possible to detect or correct an error of data transmitted to a channel having the error through the error correcting code. Alternatively, it is possible to clarify whether there is the error in data stored in a storage device.

However, in the case of the error correcting code, when the error is added to the code, it is possible to find or correct the error, but when an arithmetic operation is applied during various data processing processes, the code is again restored and converted into an original message, and then the operation should be applied to the message. The reason is that when the operation is applied in a code state, a result entirely different from a desired result is obtained, and as a result, it is impossible to apply the operation. Further, since data processing is performed after decoding the code, there is a problem in that an error which is generated during data processing cannot be detected or corrected. Further, since data to which the arithmetic operation is frequently applied may have resistance to the error in the code state only during general transfer, encoding and decoding of the code should be frequently performed, and as a result, there is a problem in that a system processing speed significantly decreases.

A technique that enables multiplication and addition by using a Reed-Muller (RM) code is proposed, but it is necessary to change an order of the RM code from a secondary order to a primary order by applying a linear conversion to every operation for a multiplication operation. That is, since the technique can be applied only to the primary RM code, the technique can operate only up to an error correction/detection limit of the primary RM code. However, not only codeword information in which the operation is performed in the linear conversion of the primary RM code is used, but codeword information before the operation is performed is also required, and as a result, there is a problem in that it is difficult to apply the technique to various devices.

Besides, as a representative method for correcting the error generated during the operation, there is an N-modular redundancy method. However, in this method, operations three times should be performed in order to correct one error generated during the operation. In general, since N=2e+1 operations should be performed in order to correct operation errors, it is very inefficient.

Besides, various methods for more efficiently removing the error generated during the operation than an N-modular redundancy method are proposed, but the proposed methods cannot guarantee the error correction. The methods are applied to signal processing, video processing, and a machine learning system in which a small number of errors do not significantly influence a performance. However, there is no other apparent method in addition to the N-modular redundancy method in a system in which a small number of errors cause a critical problem.

Accordingly, a need for a method and an apparatus for generating a fully homomorphic code, detecting errors of the fully homomorphic code, and decoding the fully homomorphic code in which it is possible to perform various operations in an encoded state, and as a result, it is possible to immediately cope with the error generated during the operation, and encoding and decoding need not be repeated.

### SUMMARY

An object to be achieved by the present disclosure is to provide an apparatus and a method for generating a fully homomorphic code, an apparatus and a method for detecting errors of the fully homomorphic code, an apparatus and a method for detecting errors of processing of fully homomorphic code, and an apparatus and a method for decoding the fully homomorphic code, which can perform various operations including an arithmetic operation, and the like in an encoding state with a code.

The objects to be solved by the present disclosure are not limited to the aforementioned object(s), and other object(s), which are not mentioned above, will be apparent to a person having ordinary skill in the art from the following description.

According to an aspect of the present disclosure, there is provided a method for generating a fully homomorphic code, which includes: generating an Idempotent polynomial; and generating a fully homomorphic code message by using the generated Idempotent polynomial and a message.

Preferably, the Idempotent polynomial may be generated by using a trace function corresponding to a finite field and a cyclotomic coset corresponding to the trace function.

Preferably, when the Idempotent polynomial is shown in Equation 1,

$$E ( x ) = {\sum }_{i = 0}^{n - 1} {ε}_{i} {x}^{i} \qquad [ Equation 1 ]$$

εᵢ which is a coefficient of the Idempotent polynomial may be determined based on coset leaders of a plurality of cyclotomic cosets corresponding to the finite field and the trace function.

Preferably, εᵢ which is the coefficient of the Idempotent polynomial may be determined by using Equation 2.

$$\begin{matrix}{ε}_{0} = {tr}_{1}^{m} ( {α}^{0} ) + … + {tr}_{1}^{m} ( {α}^{0} ) \\ {ε}_{1} = {tr}_{1}^{m} ( {α}^{- {s}_{1}} ) + … + {tr}_{1}^{m} ( {α}^{- {s}_{l}} ) \\ {ε}_{2} = {tr}_{1}^{m} ( {α}^{- 2 {s}_{1}} ) + … + {tr}_{1}^{m} ( {α}^{- 2 {s}_{l}} ) \\ … \\ {ε}_{n - 1} = {tr}_{1}^{m} ( {α}^{- ( n - 1 ) {s}_{1}} ) + … + {tr}_{1}^{m} ( {α}^{- ( n - 1 ) {s}_{l}} )\end{matrix} \qquad [ Equation 2 ]$$

Here, tr₁^{m}(α^{-is}) represents the trace function, represents the element of the finite field, N represents the total number of a plurality of cyclotomic cosets, s₁, . . . , sₗ represents a coset leader of the coset satisfying E(αⁱ)=1 among the plurality of cyclotomic cosets (however, 1≤l≤N).

Preferably, the Idempotent polynomial may be generated by using an extended Euclidean algorithm by using the generator polynomial of the cyclic code and the parity check polynomial as input values.

Preferably, in the generating of the Idempotent polynomial, a first polynomial and a second polynomial may be calculated, which correspond to the generator polynomial and the parity check polynomial, respectively by using the extended Euclidean algorithm, and the Idempotent polynomial may be generated by multiplying the generator polynomial and the first polynomial.

Preferably, in the generating of the Idempotent polynomial, when the generator polynomial is g(x), the parity check polynomial is h(x), the first polynomial is p(x), the second polynomial is q(x), and the extended Euclidean algorithm is shown in Equation 3, E(x) satisfying E(x)=p(x)g(x) as the Idempotent polynomial is generated.

p(x)g(x)+q(x)h(x)=1 modxⁿ⁻1 [Equation 3]

Preferably, the fully homomorphic code message may be expressed by a multiplication of the Idempotent polynomial and a polynomial corresponding to the message.

Preferably, when the Idempotent polynomial is E(x) and the polynomial corresponding to the message is in m(x), the fully homomorphic code message may be c(x) satisfying c(x)=m(x)E(x).

Further, according to another aspect of the present disclosure, there is provided a method for detecting errors of a fully homomorphic code, which includes: receiving a fully homomorphic code message generated by using an Idempotent polynomial generated based on a random cyclic code generator polynomial and a parity check polynomial corresponding to the generator polynomial; and detecting the errors for the fully homomorphic code message by using the parity check polynomial.

Preferably, in the detecting of the errors for the fully homomorphic code message, when a result acquired by multiplying the fully homomorphic code message by the parity check polynomial is not divided by xⁿ−1, it may be determined that the error occurs.

Preferably, when the fully homomorphic code message is c(x) and the error is e(x), if c(x)+e(x) which is a sum of the fully homomorphic code message and the error is multiplied by h(x) which is the parity check polynomial, and then c(x)h(x)+e(x)h(x)=e(x)h(x) which is the multiplication result is divided by xⁿ−1, it may be determined that the error occurs.

Further, according to yet another aspect of the present disclosure, there is provided a method for detecting errors of a fully homomorphic code, which includes: receiving a fully homomorphic code message generated by using an Idempotent polynomial generated based on a random cyclic code generator polynomial and a parity check polynomial corresponding to the generator polynomial; and detecting errors for the fully homomorphic code message by using a linear feedback shift register (LFSR) configured by the Idempotent polynomial.

Preferably, in the detecting of the errors for the fully homomorphic code message, when the fully homomorphic code message is not divided by the LFSR configured by the Idempotent polynomial, it may be determined that the error occurs.

Further, according to still yet another aspect of the present disclosure, there is provided a method for detecting errors of processing of a fully homomorphic code, which includes: receiving a fully homomorphic code message generated by using an Idempotent polynomial; generating a fully homomorphic code operation result by performing operation processing for the fully homomorphic code message; and detecting errors for the fully homomorphic code operation result.

Preferably, the operation processing may be an addition or a multiplication.

Preferably, the method may further include selectively restoring the errors for the fully homomorphic code operation result based on the error detection result.

Preferably, in the selectively restoring of the errors for the fully homomorphic code operation result, the error may be repeatedly restored according to a predetermined period.

Further, according to still yet another aspect of the present disclosure, there is provided a method for decoding a fully homomorphic code, which includes: receiving a fully homomorphic code message generated by using an Idempotent polynomial generated based on a random cyclic code generator polynomial and a parity check polynomial corresponding to the generator polynomial; and decoding the fully homomorphic code message by using an LFSR configured by the Idempotent polynomial.

Preferably, in the decoding of the fully homomorphic code message, a remainder acquired by dividing the fully homomorphic code message by the LFSR may be set as a decoding result.

Further, according to still yet another aspect of the present disclosure, there is provided a method for decoding a fully homomorphic code, which includes: receiving a fully homomorphic code message generated by using an Idempotent polynomial generated based on a random cyclic code generator polynomial and a parity check polynomial corresponding to the generator polynomial; and decoding the fully homomorphic code message based on the generator polynomial.

Preferably, in the decoding of the fully homomorphic code message, a result acquired by multiplying the fully homomorphic code message by an inverse function of the generator polynomial may be set as a decoding result.

Further, according to still yet another aspect of the present disclosure, there is provided an apparatus for generating a fully homomorphic code, which includes: a generation unit generating an Idempotent polynomial; and an encoding unit generating a fully homomorphic code message by using the generated Idempotent polynomial and a message.

Preferably, the Idempotent polynomial may be generated by using a trace function corresponding to a finite field and a cyclotomic coset corresponding to the trace function.

Preferably, the Idempotent polynomial may be generated by using an extended Euclidean algorithm by using the generator polynomial of the cyclic code and the parity check polynomial as input values.

Further, according to still yet another aspect of the present disclosure, there is provided an apparatus for detecting errors of a fully homomorphic code, which includes: a reception unit receiving a fully homomorphic code message generated by using an Idempotent polynomial generated based on a random cyclic code generator polynomial and a parity check polynomial corresponding to the generator polynomial; and a detection unit detecting the errors for the fully homomorphic code message by using the parity check polynomial.

Further, according to still yet another aspect of the present disclosure, there is provided an apparatus for detecting errors of a fully homomorphic code, which includes: a reception unit receiving a fully homomorphic code message generated by using an Idempotent polynomial generated based on a random cyclic code generator polynomial and a parity check polynomial corresponding to the generator polynomial; and a detection unit detecting the errors for the fully homomorphic code message by using an LFSR configured by the Idempotent polynomial.

Further, according to still yet another aspect of the present disclosure, there is provided an apparatus for detecting errors of processing of a fully homomorphic code, which includes: a reception unit receiving a fully homomorphic code message generated by using an Idempotent polynomial; an operation unit generating a fully homomorphic code operation result by performing operation processing for the fully homomorphic code message; and a detection unit detecting errors for the fully homomorphic code operation result.

Preferably, the apparatus may further include a restoration unit selectively restoring the errors for the fully homomorphic code operation result based on the error detection result.

Further, according to still yet another aspect of the present disclosure, there is provided an apparatus for decoding a fully homomorphic code, which includes: a reception unit receiving a fully homomorphic code message generated by using an Idempotent polynomial generated based on a random cyclic code generator polynomial and a parity check polynomial corresponding to the generator polynomial; and a decoding unit decoding the fully homomorphic code message by using an LFSR configured by the Idempotent polynomial.

Further, according to still yet another aspect of the present disclosure, there is provided an apparatus for decoding a fully homomorphic code, which includes: a reception unit receiving a fully homomorphic code message generated by using an Idempotent polynomial generated based on a random cyclic code generator polynomial and a parity check polynomial corresponding to the generator polynomial; and a decoding unit decoding the fully homomorphic code message based on the generator polynomial.

In a method and an apparatus for generating a fully homomorphic code according to exemplary embodiments of the present disclosure, there is an effect that since an arithmetic operation and various operations are possible in a code state, it is possible to immediately cope with errors generated during the operations and a new type code of which encoding and decoding need not be frequently repeated can be generated.

Further, in a method and an apparatus for detecting errors of a fully homomorphic code according to exemplary embodiments of the present disclosure, there is an effect that the errors can be detected in the code state without a need for repeating the encoding and the decoding.

Further, in a method and an apparatus for detecting errors of processing of a fully homomorphic code according to exemplary embodiments of the present disclosure, there is an effect that the errors can be detected in the code state without a need for repeating the encoding and the decoding for an operation result of the code.

Further, in a method and an apparatus for decoding a fully homomorphic code according to exemplary embodiments of the present disclosure, there is an effect that the fully homomorphic code can be easily decoded.

Further, in the fully homomorphic code according to an exemplary embodiment of the present disclosure, there is an effect that since it is possible to frequently check the error in the code state, when the problem occurs, it is possible to immediately detect which data of which device the problem occurred. In this case, the problem can be immediately isolated, and since the corresponding problem can be corrected before a physical system performs an incorrect motion, the incorrect motions of various systems can be more rapidly prevented, and it is possible to prevent an accident due to various physical systems.

Further, there is an effect that it is not necessary to apply any prior or post processing to a performed operation in performing the operation in the code state for the fully homomorphic code according to an exemplary embodiment of the present disclosure. That is, when there is no error, infinite repeated operations are possible and it can be immediately detected that the error occurs.

Further, there is an effect that an error injected intentionally from the outside by an attacker can be easily detected for the fully homomorphic code according to an exemplary embodiment of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a flowchart for describing a method for generating a fully homomorphic code according to an exemplary embodiment of the present disclosure;

FIG. 2 is a flowchart for describing a method for detecting errors of a fully homomorphic code according to an exemplary embodiment of the present disclosure;

FIG. 3 is a flowchart for describing a method for detecting errors of a fully homomorphic code according to another exemplary embodiment of the present disclosure;

FIG. 4 is a flowchart for describing a method for detecting errors of processing of a fully homomorphic code according to an exemplary embodiment of the present disclosure;

FIG. 5 is a flowchart for describing a method for decoding a fully homomorphic code according to an exemplary embodiment of the present disclosure;

FIG. 6 is a flowchart for describing a method for decoding a fully homomorphic code according to another exemplary embodiment of the present disclosure;

FIG. 7 is a block diagram for describing an apparatus for generating a fully homomorphic code according to an exemplary embodiment of the present disclosure;

FIG. 8 is a block diagram for describing an apparatus for detecting errors of a fully homomorphic code according to an exemplary embodiment of the present disclosure;

FIG. 9 is a block diagram for describing an apparatus for detecting errors of processing of a fully homomorphic code according to an exemplary embodiment of the present disclosure;

FIG. 10 is a block diagram for describing an apparatus for detecting errors of processing of a fully homomorphic code according to another exemplary embodiment of the present disclosure;

FIG. 11 is a block diagram for describing an apparatus for decoding a fully homomorphic code according to an exemplary embodiment of the present disclosure;

FIG. 12 is a diagram for describing a difference between the present disclosure and the related art; and

FIG. 13 is a diagram for describing a method for generating a fully homomorphic code, detecting errors, correcting the errors, and decoding the fully homomorphic code according to an exemplary embodiment of the present disclosure.

### DETAILED DESCRIPTION OF THE PREFERRED EMBODIMENT

The present disclosure may have various modifications and various exemplary embodiments and specific exemplary embodiments will be illustrated in the drawings and described in detail in the detailed description. However, this does not limit the present disclosure to specific exemplary embodiments, and it should be understood that the present disclosure covers all the modifications, equivalents, and replacements included within the idea and technical scope of the present disclosure. In describing each drawing, like reference numerals refer to like elements.

Terms used in the present application are used only to describe specific exemplary embodiments, and are not intended to limit the present disclosure. A singular form includes a plural form if there is no clearly opposite meaning in the context. In the present application, it should be understood that the term “include” or “have” indicates that a feature, a number, a step, an operation, a component, a part, or the combination thereof described in the specification is present, but does not exclude a possibility of presence or addition of one or more other features, numbers, steps, operations, components, parts, or combinations thereof, in advance.

If not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

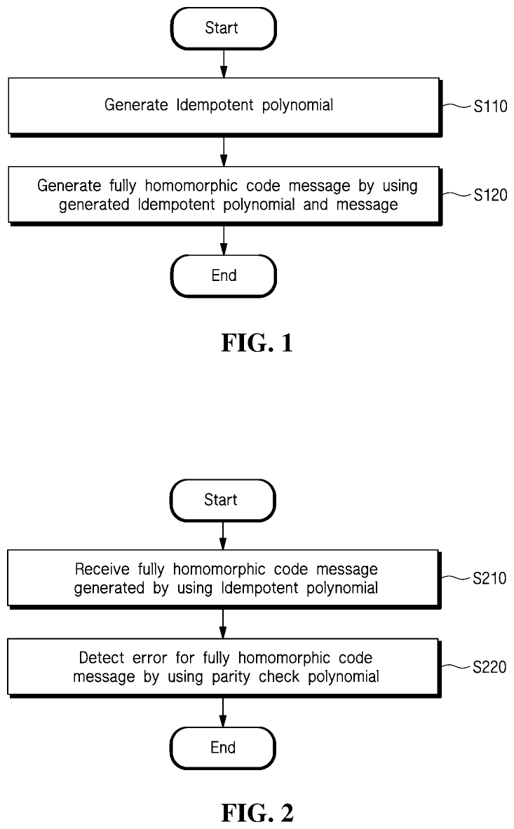

FIG. 1 is a flowchart for describing a method for generating a fully homomorphic code according to an exemplary embodiment of the present disclosure.

In step S110, a fully homomorphic code generating apparatus generates an Idempotent polynomial.

That is, the fully homomorphic code generating apparatus may generate the Idempotent polynomial by using a fact that when there is a set R of all polynomials in which an order having a coefficient which is an integer is smaller than an n order, there are one or more Idempotent polynomials

$$E ( x ) - {{\sum }_{i = l}}^{n - k} {ε}_{i} {x}^{i}$$

satisfying E²(x)=E(x) which is an n−k order for a random given k in the set.

Further, the fully homomorphic code generating apparatus may receive information for generating the Idempotent polynomial from an external device and generate the Idempotent polynomial based on the information.

Meanwhile, when a generator polynomial of a cyclic code, g(x)=gcd(E(x),xⁿ−1), there is a parity check polynomial h(x)=(xⁿ−1)/g(x).

In another exemplary embodiment, the Idempotent polynomial may be generated by using a trace function corresponding to a finite field and a cyclotomic coset corresponding to the trace function.

For example, when a finite field constituted by q elements is GF(q), if q=2^{m}, a trace function tr₁^{m}(x) may be defined as a function from GF(q) to GF(2) as follows.

$$t {r}_{1}^{m} ( x ) = {\sum }_{k = 0}^{m - 1} {x}^{{2}^{k}} \qquad [ Equation 1 ]$$

Here, x∈GF(q).

In this case, a cyclotomic coset including s for mod q−1 in GF(2) may be defined as follows.

Cₛ={s, sp, sp², . . . , sp^{m-1}} [Equation 2]

Here, sp^{m}=smod q−1, and s is referred to as a coset leader.

Then, the trace function corresponding to the cyclotomic coset may be expressed as follows.

$$t {r}_{1}^{m} ( {α}^{- is} ) = {\sum }_{k = 0}^{m - 1} {α}^{- i s {p}^{k}} = {\sum }_{j ∈ {C}_{s}} {α}^{- ij} \qquad [ Equation 3 ]$$

Here, when the Idempotent polynomial is E(x), E(x) may be expressed as follows.

$$E ( x ) = {\sum }_{i = 0}^{n - 1} {ε}_{i} {x}^{i} \qquad [ Equation 4 ]$$

Here, εᵢ represents a coefficient of the Idempotent polynomial.

In this case, it is widely known that a necessary and sufficient condition for the polynomial E(x) to become the Idempotent polynomial becomes E(αⁱ)=0 or 1 or 0≤i≤n−1.

The reason is that when a Fourier transform is applied to the finite field, there is (E(αⁱ))²=E(αⁱ) in which a convolution corresponds to a component-wise multiplication, and as a result, E(αⁱ)=0 or 1 is a solution in which two are meaningfully available.

Further, E(αⁱ)=E(αⁱ²)= . . . =E(αⁱ²^{^{m−1}}) is apparently established. As a result, the following relationship is also established. Accordingly, when this is generalized, it may be known that all cyclotomic cosets become the same value.

$$\begin{matrix}{( E ( {α}^{i} ) )}^{2} = {( {\sum }_{i = 0}^{n - 1} {ε}_{i} {x}^{i} )}^{2} \\ = {\sum }_{i = 0}^{n - 1} {ε}_{i}^{2} {x}^{2 i} \\ = E ( {α}^{2 i} )\end{matrix} \qquad [ Equation 5 ]$$

Here, εᵢ²=εᵢ.

In this case, a coefficient by an inverse formula of the Fourier transform for the finite field may be determined as follows.

$$\begin{matrix}{ε}_{i} = {\sum }_{j = 0}^{n - 1} E ( {α}^{j} ) {α}^{jj} \\ = {\sum }_{s ∈ S} E ( {α}^{s} ) {\sum }_{j ∈ {C}_{s}} {α}^{- ij} \\ = {\sum }_{s ∈ S} {tr}_{1}^{m} ( {α}^{- is} )\end{matrix} \qquad [ Equation 6 ]$$

That is, in Equation 4, the Idempotent polynomial may be generated by all available combinations in which E(αⁱ)=0 or 1.

Meanwhile, when the cyclotomic coset is additionally described, remaining elements acquired by excluding 0 from GF(q) are divided into cyclotomic cosets. In this case, the cyclotomic cosets are not redundant, and the maximum number of elements included in one cyclotomic coset is m and a smaller cyclotomic coset may have elements of a divisor number of m.

In this case, since E(αⁱ)=E(αⁱ²)= . . . =E(αⁱ²^{^{m−1}}) is established, all E(αⁱ) corresponding to the cyclotomic coset has the same value.

That is, when a coset leader of a case where E(αⁱ) is 1 is s, tr₁^{m}(α^{-is})∈GF(2) reflected to the coefficient εᵢ, and in a case where E(αⁱ) is 0, a value by the corresponding coset becomes 0.

When the above-described result is used reversely, if it may be determined whether E(αⁱ) is 0 or 1 for all cyclotomic cosets, an Idempotent polynomial corresponding thereto may be found as follows.

That is, when the total number of cyclotomic cosets is N, the total number of Idempotent polynomials is 2^{N}, the number of cosets in which E(αⁱ) is 1 is l, and respective coset leaders are s₁, . . . , sₗ, the coefficient of the Idempotent polynomial shown in Equation 4 may be determined as follows (however, 1≤l≤N).

$$\begin{matrix}{ε}_{0} = {tr}_{1}^{m} ( {α}^{0} ) + … + {tr}_{1}^{m} ( {α}^{0} ) \\ {ε}_{1} = {tr}_{1}^{m} ( {α}^{- {s}_{1}} ) + … + {tr}_{1}^{m} ( {α}^{- {s}_{l}} ) \\ {ε}_{2} = {tr}_{1}^{m} ( {α}^{- 2 {s}_{1}} ) + … + {tr}_{1}^{m} ( {α}^{- 2 {s}_{l}} ) \\ … \\ {ε}_{n - 1} = {tr}_{1}^{m} ( {α}^{- ( n - 1 ) {s}_{1}} ) + … + {tr}_{1}^{m} ( {α}^{- ( n - 1 ) {s}_{l}} )\end{matrix} \qquad [ Equation 7 ]$$

Here, tr₁^{m}(α^{-is}) represents the trace function, α represents the element of the finite field, N represents the total number of a plurality of cyclotomic cosets, and s₁, . . . , sₗ represents a coset leader of the coset satisfying E(αⁱ)=1 among the plurality of cyclotomic cosets.

As a result, all coefficients of the Idempotent polynomial shown in Equation 4 are determined as above, and as a result, the Idempotent polynomial is also uniquely determined. When the Idempotent polynomial is used as the generator polynomial, cyclic codes having a homomorphic characteristic may be continuously generated.

As such, the generation method of the Idempotent polynomial according to an exemplary embodiment of the present disclosure as a most general method has an effect of being capable of generating all Idempotent polynomials which exist in a given domain.

In another exemplary embodiment, the Idempotent polynomial may be generated by using an extended Euclidean algorithm by using the generator polynomial of the cyclic code and the parity check polynomial as input values.

For example, when there is a random cyclic code C, if the generator polynomial of the cyclic code is g(x), h(x) in which xⁿ−1=g(x)h(x) may be referred to as a parity check polynomial. Here, since h(x) and g(x) are relatively primes, there are p(x) and q(x) satisfying the following equation by the extended Euclidean algorithm.

p(x)g(x)+q(x)h(x)=1 modxⁿ−1 [Equation 8]

Here, g(x) represents the generator polynomial, h(x) represents the parity check polynomial, and p(x) and q(x) represent the polynomials.

In this case, when E(x)=p(x)g(x) and both sides of Equation 8 are mutiplied by E(x) and organized, it may be known that E(x) is an Idempotent polynomial satisfying E²(x)=E(x).

Accordingly, the fully homomorphic code generating apparatus may generate E(x) in which E(x)p(x)g(x) as the Idempotent polynomial.

Meanwhile, the present disclosure is not limited to using the Idempotent polynomial generated through the Idempotent polynomial generating method as described above, and it will be apparent to those skilled in the art that the Idempotent polynomial generated by using various methods not disclosed in the present disclosure may be used.

In step S120, the fully homomorphic code generating apparatus generates a fully homomorphic code message by using the generated Idempotent polynomial and the message.

For example, the fully homomorphic code generating apparatus may generate the fully homomorphic code message by generating a polynomial acquired by multiplying the generated Idempotent polynomial and a polynomial corresponding to the message.

In this case, a set C^{H} of polynomials acquired by multiplying the generated Idempotent polynomial by a polynomial m(x) smaller than a k order corresponding to the message may be referred to as the fully homomorphic code. In this case, h(x) becomes the parity check polynomial of the fully homomorphic code C^{H}. Further, in regard to C^{H}, the multiplication operation may be defined as a random modulus polynomial r(x).

More specifically, the fully homomorphic code generating apparatus may generate, as the fully homomorphic code message, c(x)=m(x)E(x)mod xⁿ−1 which is a polynomial acquired by multiplying the Idempotent polynomial by all polynomials m(x) smaller than the k order corresponding to the message.

Here, it may be known that the fully homomorphic code message is closed for the addition and multiplication operations.

That is, when c₁(x) and c₂(x) are two random codewords which belong to the fully homomorphic code C^{H} and c₁(x)=m₁(x)E(x) and c₂(x)=m₂(x)E(x).

In this case, when both sides are added, c₁(x)+c₂(x)=(m₁(x)+m₂(x))E(x). Accordingly, C^{H} may be closed for the addition, and the addition operation may be performed in the encoded state.

Further, when both sides are multiplied, c₁(x)c₂(x)=m₁(x)m₂(x)E²(x), and c₁(x)c₂(x)=m₁(x)m₂(x)E(x) and by a property of the Idempotent polynomial. Accordingly, C^{H} may be closed for the multiplication, and the multiplication operation may be performed in the encoded state.

For example, referring to FIG. 12, it is impossible to change the operation for the code in the existing scheme to which the related art is applied, but in the present disclosure, it is possible to apply the arithmetic operation without decoding the code, and it may be thus possible to detect/correct the error during the operation.

More specifically, in the existing scheme to which the related art is applied, decoding is required for the arithmetic operation, and there is a problem in that protection from the error which occurs during a process up to the arithmetic operation and encoding after the decoding is not made.

On the contrary, the fully homomorphic code generated through the fully homomorphic code generating method proposed in the present disclosure need not be decoded for the arithmetic operation, and may be protected from the error in all processes.

As such, in the fully homomorphic code generating method according to an exemplary embodiment of the present disclosure, there is an effect that since an arithmetic operation and various operations are possible in a code state, it is possible to cope with errors generated during the operations, and encoding and decoding need not be frequently repeated.

FIG. 2 is a flowchart for describing a method for detecting errors of a fully homomorphic code according to an exemplary embodiment of the present disclosure.

In step S210, an error detecting apparatus receives the fully homomorphic code message generated by using the Idempotent polynomial generated based on a random cyclic code generator polynomial and the parity check polynomial corresponding to the generator polynomial.

For example, the error detecting apparatus may receive the fully homomorphic code message generated through the fully homomorphic code generating method described by using FIG. 1 through a wired or wireless communication means.

In step S220, the error detecting apparatus detects the error for the fully homomorphic code message received by using the parity check polynomial.

In this case, the error detecting apparatus may detect the error by multiplying both sides by the parity check polynomial h(x) with respect to a codeword c in which c(x)=m(x)E(x). In this regard, since E(x)h(x) is a multiple of xⁿ−1, a property in which c(x)h(x) continuously becomes 0 mod xₙ−1 is used.

More specifically, when a random error e(x) occurs in c(x), c(x)+e(x) is obtained, and the error detecting apparatus may multiply c(x)+e(x) by h(x). In this case, the multiplication result becomes c(x)h(x)+e(x)h(x)=e(x)h(x) by the above-described property, and if e(x) is not the element of C^{H}, e(x)h(x)≠0 mod xⁿ−1 is continuously established.

That is, the error detecting apparatus may detect the error when a polynomial other than 0 is obtained by multiplying the fully homomorphic code message by h(x).

As such, the method for detecting errors of a fully homomorphic code according to exemplary embodiments of the present disclosure has an effect that the errors can be detected in the code state without a need for decoding the code.

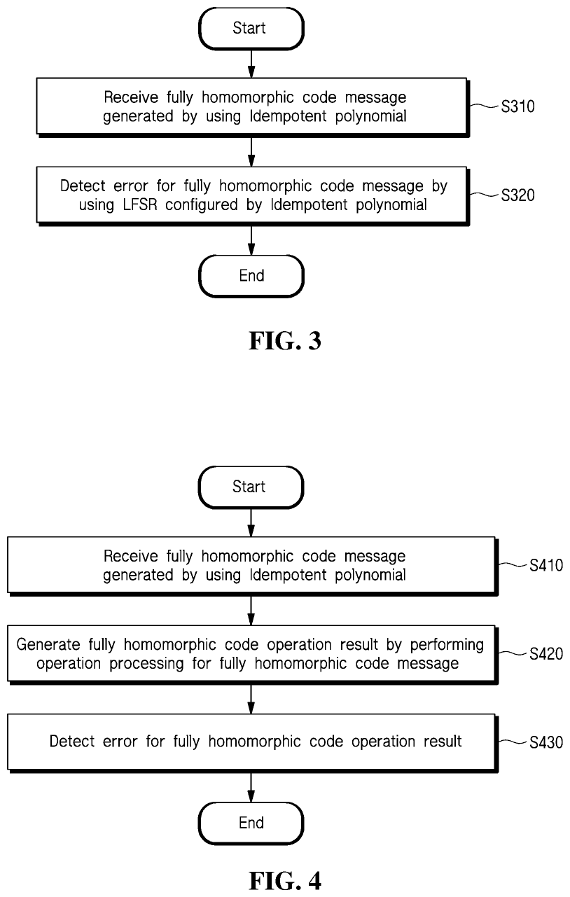

FIG. 3 is a flowchart for describing a method for detecting errors of a fully homomorphic code according to another exemplary embodiment of the present disclosure.

In step S310, an error detecting apparatus receives the fully homomorphic code message generated by using the Idempotent polynomial generated based on a random cyclic code generator polynomial and the parity check polynomial corresponding to the generator polynomial.

For example, the error detecting apparatus may receive the fully homomorphic code message generated through the fully homomorphic code generating method described by using FIG. 1 through a wired or wireless communication means.

In step S320, the error detecting apparatus detects the error for the fully homomorphic code message by using a linear feedback shift register (LFSR) configured by the Idempotent polynomial.

In this case, the error detecting apparatus may detect the error when the remainder is not 0 by using a property that the remainder becomes 0 when dividing c(x) by the LFSR configured by E(x) with respect to the codeword c in which c(x)=m(x)E(x).

FIG. 4 is a flowchart for describing a method for detecting errors of processing of a fully homomorphic code according to an exemplary embodiment of the present disclosure.

In step S410, the error detecting apparatus receives the fully homomorphic code message generated by using the Idempotent polynomial.

For example, the error detecting apparatus may receive the fully homomorphic code message generated through the fully homomorphic code generating method described by using

FIG. 1 through a wired or wireless communication means.

In step S420, the error detecting apparatus may generate a fully homomorphic code operation result by performing operation processing for the fully homomorphic code message.

For example, the error detecting apparatus may generate the fully homomorphic code operation result by performing the addition and multiplication operations of the fully homomorphic code message and another fully homomorphic code message.

Last, in step S420, the error detecting apparatus detects the error for the fully homomorphic code operation result.

For example, the error detecting apparatus may detect the error for the fully homomorphic code operation result by using the error detecting method of the fully homomorphic code described by using FIGS. 2 and 3 above.

In another exemplary embodiment, the error detecting apparatus may selectively restore the error of the fully homomorphic code operation result based on the error detection result.

That is, when the error for the fully homomorphic code operation result is detected, the error detecting apparatus may restore the error by removing the detected error from the fully homomorphic code operation result.

For example, when the random error e(x) occurs in c(x) which is the fully homomorphic code operation result, c(x)+e(x) is obtained, and the error detecting apparatus may multiply c(x)+e(x) by h(x). In this case, the multiplication result becomes c(x)h(x)+e(x)h(x)=e(x)h(x), and if e(x) is not the element of C^{H}, e(x)h(x)≠0 mod Xⁿ−1 is continuously established. Accordingly, when a result acquired by multiplying the fully homomorphic code operation result by h(x) is not a multiple of xⁿ−1, the error detecting apparatus may restore the error by subtracting a result (i.e., e(x)) acquired by dividing the remainder by h(x) from the fully homomorphic code operation result.

On the contrary, the error detecting apparatus may not restore the error when the error for the fully homomorphic code operation result is not detected.

In yet another exemplary embodiment, the error detecting apparatus may restore the error repeatedly according to a predetermined period.

For example, the error detecting apparatus may not restore the detected error each time, but may perform the operation while enduring a predetermined degree of error and when a predetermined period is reached, the error detecting apparatus may restore the error.

As such, the method for detecting errors of processing of the fully homomorphic code according to an exemplary embodiment of the present disclosure has an effect that the error is detected in the code state to immediately correct the error without performing decoding even in the middle of operation processing for the fully homomorphic code message.

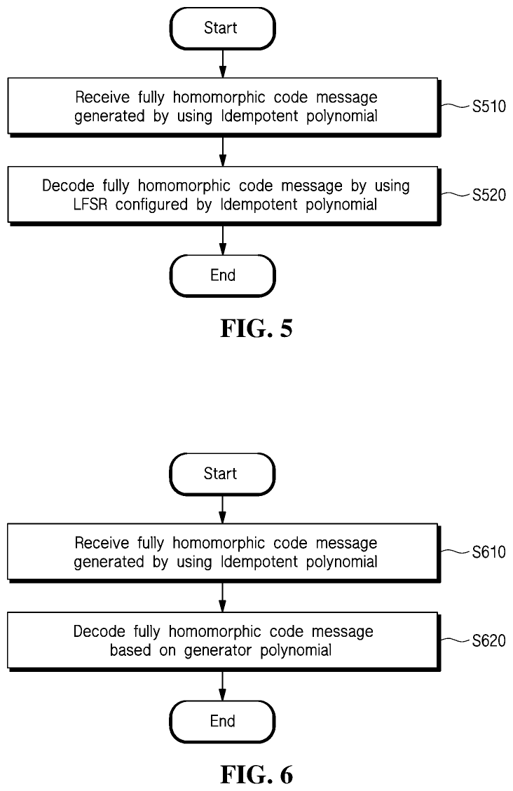

FIG. 5 is a flowchart for describing a method for decoding a fully homomorphic code according to an exemplary embodiment of the present disclosure.

In step S510, the fully homomorphic code decoding apparatus receives the fully homomorphic code message generated by using the Idempotent polynomial generated based on a random cyclic code generator polynomial and the parity check polynomial corresponding to the generator polynomial.

For example, the error detecting apparatus may receive the fully homomorphic code message generated through the fully homomorphic code generating method described by using FIG. 1 through a wired or wireless communication means.

In step S520, the fully homomorphic code decoding apparatus decodes the fully homomorphic code message by using the LFSR configured by the Idempotent polynomial.

For example, the fully homomorphic code decoding apparatus may divide c(x) by the LFSR configured by E(x) for the codeword c which is c(x)=m(x)E(x and decode the remainder with m(x) which is the polynomial corresponding to the message.

FIG. 6 is a flowchart for describing a method for decoding a fully homomorphic code according to another exemplary embodiment of the present disclosure.

In step S610, the fully homomorphic code decoding apparatus receives the fully homomorphic code message generated by using the Idempotent polynomial generated based on a random cyclic code generator polynomial and the parity check polynomial corresponding to the generator polynomial.

For example, the error detecting apparatus may receive the fully homomorphic code message generated through the fully homomorphic code generating method described by using FIG. 1 through a wired or wireless communication means.

In step S620, the fully homomorphic code decoding apparatus decodes the fully homomorphic code message based on the generator polynomial.

That is, when the fully homomorphic code message is generated from the cyclic code having the generator polynomial p(x), the fully homomorphic code decoding apparatus may confirm that there is no error for the fully homomorphic code message, and then restore the fully homomorphic code message by using a decoding method of the cyclic code.

That is, the fully homomorphic code decoding apparatus may restore the fully homomorphic code message c(x) by using a decoding method of the cyclic code. In this case, since the restored message is m′(x)=m(x)p(x) the fully homomorphic code decoding apparatus may decode an original message m(x) by calculating m′(x)/p(x).

Here, since gcd(p(x),xⁿ−1)=1, there is a polynomial p⁻¹(x) in which p(x)p⁻¹(x)=1mod xⁿ−1 Accordingly, the fully homomorphic code decoding apparatus may decode the original message m(x) by calculating m′(x)/p(x)=m′(x)p⁻¹(x).

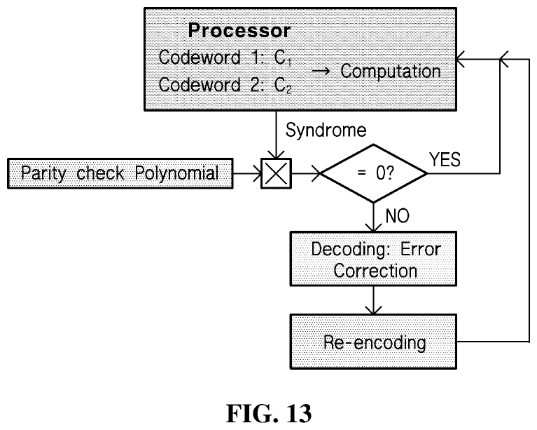

FIG. 13 is a diagram for describing a method for generating a fully homomorphic code, detecting errors, and correcting the errors according to an exemplary embodiment of the present disclosure.

Referring to FIG. 13, a data error detecting system within an electronic circuit may be implemented by using a method for generating a fully homomorphic code, detecting errors, correcting the errors, and decoding the fully homomorphic code according to an exemplary embodiment of the present disclosure.

More specifically, a processor which is installed in the electronic circuit and to which the method for generating a fully homomorphic code, detecting errors, correcting the errors, and decoding the fully homomorphic code is applied may generate codewords C₁ and C₂. In addition, error checking may be performed before multiplication between the codewords C₁ and C₂. In this case, the error checking may be performed by a scheme of multiplying the codewords by the parity checking polynomial.

If there is no problem after the error checking, the multiplication is performed as it is, and if the problem is discovered in the error checking, decoding may be performed before the multiplication is performed, and the error may be corrected during this process. Further, after the error is corrected, the codeword may be generated via encoding again.

Meanwhile, in the case of the addition, the decoding need not be performed each time, and the operation may be performed while enduring errors of a predetermined number or more according to an error correction capability and an error probability of a used code. In addition, the error correction through the decoding may be performed after performing N operations. Further, a subsequent operation may be performed by encoding again after the error correction.

In another exemplary embodiment, the method for generating a fully homomorphic code, detecting errors, and correcting the errors according to an exemplary embodiment of the present disclosure may be used for coping with an error injection attack.

In recent years, a subchannel attack method capable of restoring confidential information of a password algorithm through the error injection attack for the password algorithm has been widely known. A main coping method with such an attack is a method that does not use an encrypted message with the error by rapidly sensing that the error is injected. In this case, a general method for sensing the error is to perform the same encryption operation independently twice or more, and compare the results. That is, when two independent operations show different results, it is regarded that the error is injected and a corresponding encrypted message (or signature) value is discarded.

However, when the fully homomorphic code is used, the encryption operation based on the arithmetic operation is possible in the encoded state, and in this case, the encryption operation may be more efficiently performed than a cost of repeating the same operation twice. That is, when the fully homomorphic code is used, a final result is multiplied by the parity check polynomial to check whether the error occurs.

As a representative example, there is an implementation scheme based on an RSA-Chinese Remainder Theorem (CRT). Known is a method for restoring s by using CRT after calculating sₚ=m^{e}modp and s_{q}=m^{e}modq and instead of calculating s=m^{e}modn (here, n=pq) for shortening an operation time in RSA. However, when the error occurs in sₚ or s_{q}, if a difference between a signature s′ with the error and s with no error is obtained, the difference becomes gcd(s−s′,n)=p. That is, a prime factor p of n may be found, and as a result, q may be immediately known, and an RSA password may be decrypted.

In this case, when the method proposed by the present disclosure is applied to m, which is encoded, the operation is possible in a codeword state, and it may be confirmed that the error is injected by the multiplication with the parity check polynomial.

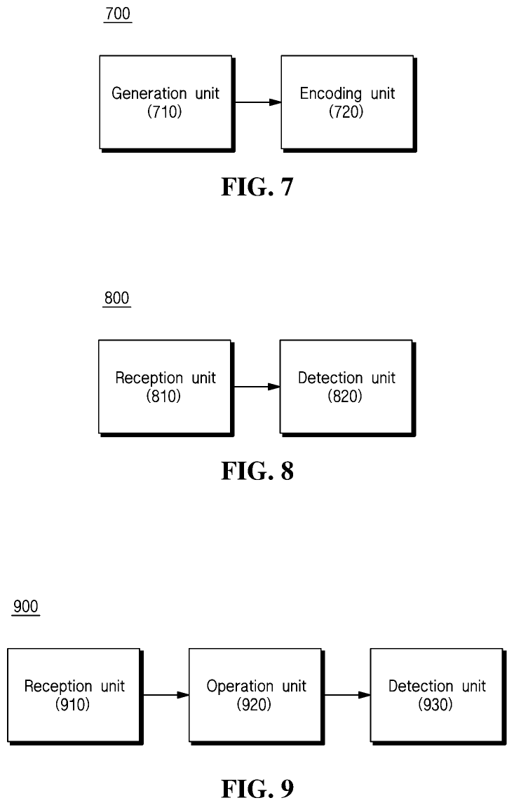

FIG. 7 is a block diagram for describing an apparatus for generating a fully homomorphic code according to an exemplary embodiment of the present disclosure.

Referring to FIG. 7, the apparatus 700 for generating a fully homomorphic code according to an exemplary embodiment of the present disclosure includes a generation unit 710 and an encoding unit 720.

The generation unit 710 generates the Idempotent polynomial.

The encoding unit 720 generates the fully homomorphic code message by using the generated Idempotent polynomial and the message.

In another exemplary embodiment, the Idempotent polynomial may be generated by using a trace function corresponding to a finite field and a cyclotomic coset corresponding to the trace function.

In yet another exemplary embodiment, the Idempotent polynomial may be generated by using an extended Euclidean algorithm by using the generator polynomial of the cyclic code and the parity check polynomial as input values.

FIG. 8 is a block diagram for describing an apparatus for detecting errors of a fully homomorphic code according to an exemplary embodiment of the present disclosure.

Referring to FIG. 8, the apparatus 800 for detecting errors of a fully homomorphic code according to an exemplary embodiment of the present disclosure includes a reception unit 810 and a detection unit 820.

The reception unit 810 receives the fully homomorphic code message generated by using the Idempotent polynomial generated based on a random cyclic code generator polynomial and the parity check polynomial corresponding to the generator polynomial.

The detection unit 820 detects errors for the fully homomorphic code message by using the generator polynomial and the parity check polynomial.

In another exemplary embodiment, the detection unit 820 may detect the errors for the fully homomorphic code message by using LFSR configured by the Idempotent polynomial.

FIG. 9 is a block diagram for describing an apparatus for detecting errors of processing of a fully homomorphic code according to an exemplary embodiment of the present disclosure.

Referring to FIG. 9, the apparatus 900 for detecting errors of processing of a fully homomorphic code according to an exemplary embodiment of the present disclosure includes a reception unit 910, an operation unit 920, and a detection unit 930.

The reception unit 910 receives the fully homomorphic code message generated by using the Idempotent polynomial.

The operation unit 920 generates the fully homomorphic code operation result by performing operation processing for the fully homomorphic code message.

Last, the detection unit 930 detects the error for the fully homomorphic code operation result.

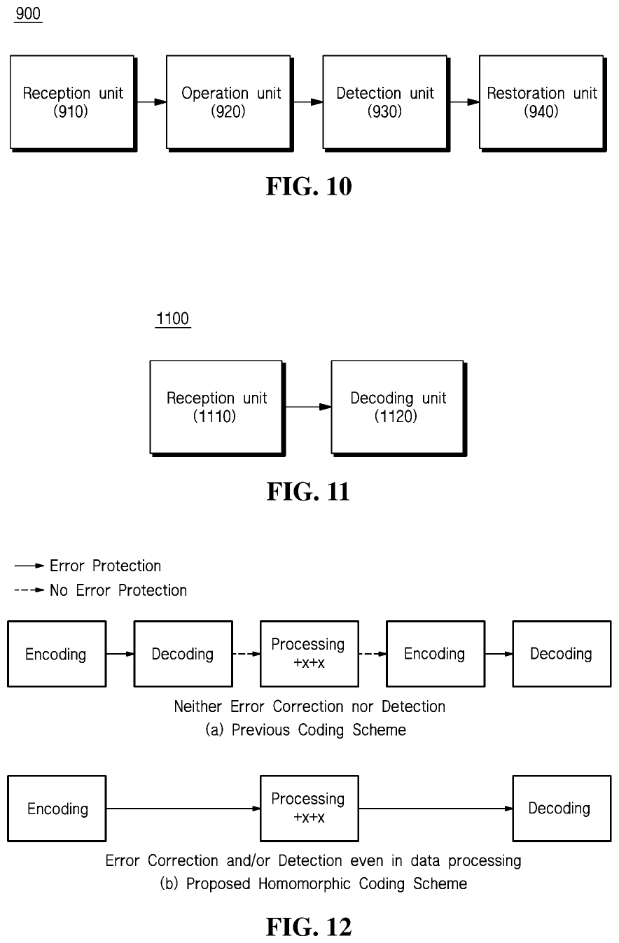

FIG. 10 is a block diagram for describing an apparatus for detecting errors of processing of a fully homomorphic code according to another exemplary embodiment of the present disclosure.

Referring to FIG. 10, the apparatus 900 for detecting errors of processing of a fully homomorphic code according to another exemplary embodiment of the present disclosure includes the reception unit 910, the operation unit 920, the detection unit 930, and a restoration unit 940.

The reception unit 910 receives the fully homomorphic code message generated by using the Idempotent polynomial.

The operation unit 920 generates the fully homomorphic code operation result by performing operation processing for the fully homomorphic code message.

The detection unit 930 detects the error for the fully homomorphic code operation result.

Last, the restoration unit 940 selectively restores the error of the fully homomorphic code operation result based on the error detection result.

FIG. 11 is a block diagram for describing an apparatus for decoding a fully homomorphic code according to an exemplary embodiment of the present disclosure.

Referring to FIG. 11, the apparatus 1100 for decoding a fully homomorphic code according to an exemplary embodiment of the present disclosure includes a reception unit 1110 and a decoding unit 1120.

The reception unit 1110 receives the fully homomorphic code message generated by using the Idempotent polynomial generated based on a random cyclic code generator polynomial and the parity check polynomial corresponding to the generator polynomial.

The decoding unit 1120 decodes the fully homomorphic code message by using the LFSR configured by the Idempotent polynomial.

In another exemplary embodiment, the decoding unit 1120 may decode the fully homomorphic code message based on the generator polynomial.

Meanwhile, the method and the apparatus for generating a fully homomorphic code, the method and the apparatus for detecting errors of the fully homomorphic code, the method and the apparatus for detecting errors of processing of the fully homomorphic code, and the method and the apparatus for decoding the fully homomorphic code proposed in the present disclosure are applicable to the following fields.

In recent years, various unmanned mobile systems (drones, autonomous driving vehicles, unmanned robots, and unmanned ships) have been rapidly developed, and applied to an actual real life. An autonomous driving system applicable to the unmanned mobile systems autonomously determines a surrounding situation, and then operates without inference by the human. Accordingly, when a wrong motion occurs, it is difficult that a problem is immediately determined and solved by a human manager, and a method that can autonomously correct an abnormal motion or a wrong value is required.

The largest threat of the autonomous driving system is a case where the autonomous driving system is used as a weapon for attack. In this case, the autonomous driving system may not be a technique which makes the human comfortable, but a technique that seriously threats a safety.

Specifically, the autonomous driving system may have values which are not taken in an original state due to external hacking. Accordingly, a means that may first determine this problem and restore the autonomous driving system to the original state is required. Therefore, an inaccurate computation error occurs, and as a result, the problem may be caused.

Further, even within a general electronic device, the error may occur during the motion. For example, a motion of a driving device, which may not be understood, such as a sudden unintended acceleration of a vehicle is also likely to be caused due to the error in an internal electronic control device.

Further, when an aircraft performs a wrong motion due to a small error or an incorrect motion, a large accident may occur. Accordingly, a device for sensing the abnormality through various sensors, enduring even the error, and maintaining a normal level of motion is required.

This is made at a sensor level, and may be sensed after driving a physical actuator after abnormal data is generated or after the problem already occurs in generation of normal data. Accordingly, if it may be confirmed whether abnormality occurs in the middle of processing data, the abnormality may be sensed more quickly.

In particular, when the abnormality may be sensed at a data level, it may also be specified in which device the problem occurs, and the device with the problem is rapidly notified or replaced to prevent the problem from being serious in advance.

In summary, the technique proposed in the present disclosure may be applied to all types of parts which are subjected to data processing, such as system semiconductors and memory semiconductors which are parts for the drones, the autonomous driving vehicles, the unmanned robots, and the unmanned ships, and various modules of the corresponding products. Further, the technique may be applied to facilities, parts, sensors, communication modems, and the like for factory automation in an industrial control system. Further, the technique may be applied to various sensors, actuators, network hubs, and the like in Internet of things part equipment. Further, the technique may be applied to a vehicular semiconductor, an ECU, a TCU, a vehicular sensor, an actuator, etc., in vehicular parts.

The above-described method may be implemented through various means. For example, the embodiments of the present disclosure may be implemented by hardware, firmware, software, or combinations thereof.

In the case of implementation by hardware, the method according to the exemplary embodiments of the present disclosure may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the method according to the exemplary embodiments of the present invention may be implemented in the form of a module, a procedure, a function, and the like to perform the functions or operations described above. A software code may be stored in the memory unit and executed by the processor. The memory unit may be positioned inside or outside the processor and may transmit and receive data to/from the processor by various means already known.

Hereinabove, the exemplary embodiments disclosed in the present specification have been described with reference to the accompanying drawings. The exemplary embodiments illustrated in the respective drawings should not be limitedly construed as such and may be combined with each other by those skilled in the art, which are well-acquainted with the contents of the present specification, and when the exemplary embodiments are combined, it may be construed that some components may also be omitted.

Here, terms or words used in the present specification and the claims should not be construed only as conventional or dictionary meanings, and should be construed as meanings and concepts that conform to the technical spirit disclosed in the present specification.

Accordingly, configurations illustrated in the embodiments and drawings disclosed in the present specification are only an exemplary embodiment disclosed in the present specification and do not represent all of the technical spirit disclosed in the present specification, and thus it is to be understood that various equivalents and modified examples, which may replace the configurations, are possible when filing the present application.

What is claimed is:

1. A method for generating a fully homomorphic code, the method comprising:
generating an Idempotent polynomial; and
generating a fully homomorphic code message by using the generated Idempotent polynomial and a message.

2. The method of claim 1, wherein the Idempotent polynomial is generated by using a trace function corresponding to a finite field and a cyclotomic coset corresponding to the trace function.

3. The method of claim 2, wherein when the Idempotent polynomial is shown in Equation 1,
$$E ( x ) = {\sum }_{i = 0}^{n - 1} {ε}_{i} {x}^{i} \qquad [ Equation 1 ]$$
εᵢ which is a coefficient of the Idempotent polynomial is determined based on coset leaders of a plurality of cyclotomic cosets corresponding to the finite field and the trace function.

4. The method of claim 3, wherein εᵢ which is the coefficient of the Idempotent polynomial is determined by using Equation 2:
$$\begin{matrix}{ε}_{0} = {tr}_{1}^{m} ( {α}^{0} ) + … + {tr}_{1}^{m} ( {α}^{0} ) \\ {ε}_{1} = {tr}_{1}^{m} ( {α}^{- {s}_{1}} ) + … + {tr}_{1}^{m} ( {α}^{- {s}_{l}} ) \\ {ε}_{2} = {tr}_{1}^{m} ( {α}^{- 2 {s}_{1}} ) + … + {tr}_{1}^{m} ( {α}^{- 2 {s}_{l}} ) \\ … \\ {ε}_{n - 1} = {tr}_{1}^{m} ( {α}^{- ( n - 1 ) {s}_{1}} ) + … + {tr}_{1}^{m} ( {α}^{- ( n - 1 ) {s}_{l}} )\end{matrix} \qquad [ Equation 1 ]$$
Here, tr₁^{m}(α^{-is}) represents the trace function, α represents an element of the finite field, N represents the total number of the plurality of cyclotomic cosets, and s₁, . . . m sₗ represents the coset leader of the coset satisfying E(αⁱ)=1 among the plurality of cyclotomic cosets (however, 1≤l≤N).

5. The method of claim 1, wherein the Idempotent polynomial is generated by using an extended Euclidean algorithm by using a generator polynomial of a cyclic code and a parity check polynomial as input values.

6. The method of claim 5, wherein in the generating of the Idempotent polynomial, a first polynomial and a second polynomial are calculated, which correspond to the generator polynomial and the parity check polynomial, respectively by using the extended Euclidean algorithm, and
the Idempotent polynomial is generated by multiplying the generator polynomial and the first polynomial.

7. The method of claim 6, wherein in the generating of the Idempotent polynomial,
when the generator polynomial is g(x), the parity check polynomial is h(x), the first polynomial is p(x), the second polynomial is q(x), and the extended Euclidean algorithm is shown in Equation 3,
E(x) satisfying E(x)=p(x)g(x) as the Idempotent polynomial is generated:
p(x)g(x)+q(x)h(x)=1 mod xⁿ−1 [Equation 3]

8. The method of claim 1, wherein the fully homomorphic code message is expressed by a multiplication of the Idempotent polynomial and a polynomial corresponding to the message.

9. The method of claim 1, wherein when the Idempotent polynomial is E(x) and a polynomial corresponding to the message is m(x), the fully homomorphic code message is c(X) satisfying c(x)=m(x)E(x).

10. An apparatus for generating a fully homomorphic code, the apparatus comprising:
a generation unit generating an Idempotent polynomial; and
an encoding unit generating a fully homomorphic code message by using the generated Idempotent polynomial and a message.

11. The apparatus of claim 10, wherein the Idempotent polynomial is generated by using a trace function corresponding to a finite field and a cyclotomic coset corresponding to the trace function.

12. The apparatus of claim 10, wherein the Idempotent polynomial is generated by using an extended Euclidean algorithm by using a generator polynomial of a cyclic code and a parity check polynomial as input values.
